(19) United States
(12) Patent Application Publication
(10) Pub. No.: US 2007/0050525 A1
(43) Pub. Date: Mar. 1, 2007

(54) [VIRTUAL COM PORT FOR REMOTE I/O CONTROLLER]

(75) Inventors: Yi-Ming Pao, TAIPEI (TW); Yu-Hung Cheng, TAIPEI (TW)

Correspondence Address: MOXA TECHNOLOGIES CO., LTD, P.O. BOX 108-00403, TAIPEI, TW

(73) Assignee: MOXA TECHNOLOGIES CO., LTD., Shing Tien City (TW)

(21) Appl. No.: 11/162,003

(22) Filed: Aug. 25, 2005

(51) Int. Cl. G06F 13/38

(52) U.S. Cl. 710/62

(57) ABSTRACT

A virtual COM port for remote I/O controller comprises a virtual COM port in a host end. The virtual COM port is connected to a remote I/O controller via a network, wherein the virtual COM port is adopted for receiving and converting commands or data of a COM port interface transmitted from the host end into an acceptable format for the remote I/O controller, and then transmitting to the remote I/O controller for processing. The virtual COM port is also adopted for receiving and converting commands or data transmitted from the remote I/O controller via the network into an acceptable format for the COM port interface, and then transmitting to the host end for processing.

### BACKGROUND OF THE INVENTION

1. Field of the Invention

The present invention generally relates to a virtual COM port for remote I/O controller, and more particularly to a virtual COM port for remote I/O controller comprising a virtual COM port capable of receiving and converting commands or data transmitted from the host end or the remote I/O controller into the acceptable format for the remote I/O controller or the host end and then transmitting it to the remote I/O controller or the host end for processing.

2. Description of the Related Art

The Internet has changed the peoples' life style, the operation and development of business. The great demand of the Internet for commercial purpose advantageously reduces wiring costs because one network cable may be used to connect hundreds of thousands or millions electronic elements (components) and thereby replace the conventional transmission method of connecting few hundreds of transmission wires side by side. Thus, overall costs on wiring and the space occupation for wiring can be reduced. Furthermore, even the elements for connecting to the network are taken as the objects would increase or deleted by the software. When the elements break down, the control end receives a message through the network displayed on the monitor. Therefore, the commercial network is the very essential tool for today's economy.

However, the general control system uses a host end to connect one or plural remote I/O controllers through the network, thus the programmer may program and use the host end to issue commands to the element connected to the remote I/O controller in order to control the element or to transmit data. The remote I/O controller provides an environmental interface as the communication standard with the host end so that when the programmer develops an appliance program, the command of the environmental interface may be used to design a program to control the remote I/O controller to enable the remote I/O controller to execute the command transmitted from the host end. However, the environmental interface provided by the general remote I/O controller mostly are technical and systematic, for example, the elements of the dynamic link library (DLL) and the ActiveX, the new technology, programmed by Microsoft, enable the software to be developed in any language operable with each other. These two environment interfaces require the programmer with good knowledge about the system for programming purposes, which provides substantial inconvenience to the programmer.

Furthermore, the programmer has to be very careful while using the DLL as the program can be overloaded for execution only when needed. In other words, when the program is not running, the system source must be released; the programmer also has to understand the detail description and the command procedure of each application program interface (API). Nevertheless, practically, the system source is often being wasted due to the ignorance of the programmer and this may also render system unstable.

The programmer need not execute loading and releasing for using ActiveX elements but need to install and register the element before using it, and it is not significantly different from the DLL.

Therefore, to enable the programmer to easily use the environmental interface of the remote I/O controller to design the program is an important issue for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a virtual COM port for remote I/O controller.

According to an aspect of the present invention, the virtual COM port receives the command or data from the host end or the remote I/O controller, and converts the received command or data into an acceptable format for the remote I/O controller or the host end and then is transmitted to the remote I/O controller or the host end for processing. Thus, time of designing is reduced and the system stability is increased, and the overall cost is reduced as well.

According to an embodiment of the present invention, the virtual COM port for remote I/O controller comprises a host end with an operating system, a user program and a virtual COM port. The operating system comprises a COM port interface. The virtual COM port is adopted for connecting to a remote I/O controller interface of a remote I/O controller through a network, and the virtual COM port is adopted for receiving command or data from the host end or the remote I/O controller, and for converting received command or data into the acceptable format for the remote I/O controller or the host end and then transmitting to the remote I/O controller and the host end for processing an thereby enabling the programmer or the user to use a conventional COM port interface to avoid error occurred due to programmer or user not being familiar with the remote I/O controller interface. Thus, the time of designing is reduced and the system stability is increased, and also the overall cost is reduced.

### BRIEF DESCRIPTION OF THE DRAWINGS

For a more complete understanding of the present invention, reference will now be made to the following detailed description of preferred embodiments taken in conjunction with the following accompanying drawings.

FIG. 1 is a block diagram of a virtual COM port for remote I/O controller according to an embodiment of the present invention.

FIG. 2 is a block diagram of a virtual COM port for remote I/O controller according to another embodiment of the present invention.

### DETAILED DESCRIPTION OF THE PREFERRED EMBODIMENT

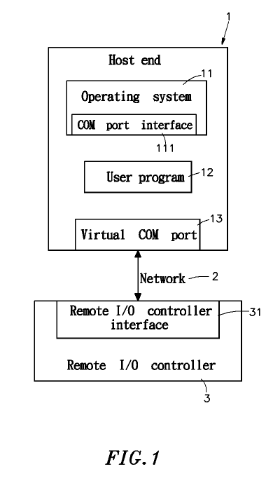

Referring to FIG. 1, the virtual COM port for remote I/O controller comprises a host end 1 having an operating system 11, a user program 12 and a virtual COM port 13.

The operating system 111 comprises a COM port interface 111.

The user program 12 comprises software and related programs designed according to the user's requirement to accept command and control methods of the COM port interface 111.

The virtual COM port 13 is not a physical COM port and is a port built by the programmer to execute the command of the COM port interface 111. The virtual COM port 13 is connected to the remote I/O controller interface 31 of a remote I/O controller 3 through a network 2.

When the user executes the user program 12 designed by the programmer, the user program 12 transmits the command of the COM port interface 111 to the remote I/O controller interface 31 of the remote I/O controller 3 through the virtual COM port 13 and the network 2. During the transmission, the virtual COM port 13 converts the command into an acceptable format for the remote I/O controller interface 31 upon receiving the command and then transmits it to the remote I/O controller interface 31 for processing through the network 2. Furthermore, if the remote I/O controller 3 transmits the processing result back to the host end 1, the remote I/O controller 3 transmits data or command through the remote I/O controller interface 31 and the network 2 to the virtual COM port 13 of the host end 1. The virtual COM port 13 further converts the received command or data into the acceptable format for the COM port interface 111, and then transmits it to the COM port interface 111 for processing.

According to the above description, the command and the control methods of the COM port interface 111 may be used by the programmer to design or to amend the user program 12. Thus, the difficulty of designing and using the remote I/O controller interface 31 of the remote I/O controller 3 that the programmer or the user is unfamiliar with can be resolved and error due to such problems that would render the system unstable can be effectively reduced.

The COM port interface 111 is an essential component of operating system 11, and the host end 1 and the most of the peripheral elements connected to the host end 1 use the COM port interface 111. Therefore, most of the programmers and users are quite familiar with the operation of the COM port interface 111. Thus, by converting the command or data using the virtual COM port 13, it is possible to use the familiar COM port interface 111 to serve as a communication interface between the remote I/O controller 3 and the host end 1 so that error due to programmer or user is not being familiar with the COM port interface 111 may be effectively reduced. The programming time can be effectively reduced and the system stability can be effectively increased. Thus, the overall cost can be effectively reduced.

The operating system 11 may be comprised of Windows or Linux, and the COM port interface 111 in Linux is called TTY interface. Although the name is different from the COM port interface 111, but the commands, the control methods and the functions are all identical. Therefore, the COM port interface 111 and the TTY interface are both included within the scope of the present invention.

Additionally, the network 2 may be comprised of TCP/IP, Ethernet or Wireless LAN. The remote I/O controller 3 may be comprised of electronic switch or the analog sensor. The host end 1 may be a personal computer or an industrial computer.

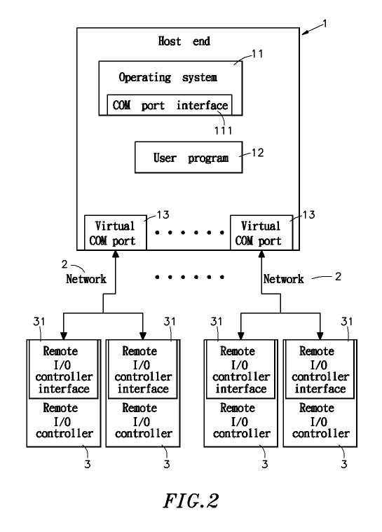

As shown in FIG. 2, the host end 1 comprises a plurality of virtual COM ports 13 connected to a plurality of remote I/O controller 3 via network 2. Thus, the host end 1 can control the plurality of remote I/O controller 3 through one or more virtual COM ports 13.

According to the important aspect of the present invention, the command or data is converted into an acceptable format for the COM port interface 111 in the host end 1 or the remote I/O controller interface 31 connected to the network 2 so that the COM port interface 111 may effectively serve as a communication interface between the host end 1 and the remote I/O controller 3.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A virtual COM port for remote I/O controller, comprising a virtual COM port in a host end, said virtual COM port connecting to a remote I/O controller via a network, wherein said virtual COM port is adopted for receiving and converting commands or data of a COM port interface transmitted from said host end into an acceptable format for said remote I/O controller, and transmitting to said remote I/O controller for processing, and wherein said virtual COM port is also adopted for receiving and converting commands or data transmitted from said remote I/O controller via said network into an acceptable format for said COM port interface, and transmitting to said host end for processing.

2. The virtual COM port for remote I/O controller according to claim 1, wherein said host end comprises an operating system with said COM port interface.

3. The virtual COM port for remote I/O controller according to claim 2, wherein said operating system comprises Windows.

4. The virtual COM port for remote I/O controller according to claim 2, wherein said operating system comprises Linux.

5. The virtual COM port for remote I/O controller according to claim 1, wherein said remote I/O controller comprises a remote I/O controller interface connected to said network.

6. The virtual COM port for remote I/O controller according to claim 1, wherein said network comprises Ethernet.

7. The virtual COM port for remote I/O controller according to claim 1, wherein said network comprises Wireless LAN.

8. A virtual COM port for remote I/O controller, comprising an operating system, a user program and an virtual COM port in a host end, said operating system comprising a COM port interface, wherein a programmer uses commands and control methods of said COM port interface to design said user program and said virtual COM port is adopted to receive and covert commands or data of said COM port interface transmitted from said host end into an acceptable format for an electronic switch, and transmit to a connected electronic switch for processing via a network, and wherein said virtual COM port is also adopted to receive and convert commands or data transmitted from said electronic switch into an acceptable format for said COM port interface, and transmit to said host end for processing.

9. The virtual COM port for remote I/O controller according to claim 8, wherein said operating system comprises Windows.

10. The virtual COM port for remote I/O controller according to claim 8, wherein said operating system comprises Linux.

11. The virtual COM port for remote I/O controller according to claim 8, wherein said network comprises Ethernet.

12. The virtual COM port for remote I/O controller according to claim 8, wherein said network comprises Wireless LAN.

13. A virtual COM port for remote I/O controller, comprising an operating system, a user program and an virtual COM port in a host end, said operating system comprising a COM port interface, wherein a programmer uses commands and control methods of said COM port interface to design said user program and said virtual COM port is adopted to receive and convert commands or data of said COM port interface transmitted from said host end into an acceptable format for an analog sensor, and then transmit to a connected analog sensor for processing through a network, and wherein said virtual COM port is also adopted to receive and convert commands or data transmitted from said analog sensor into an acceptable format for said COM port interface, and then transmit to said host end for processing.

14. The virtual COM port for remote I/O controller according to claim 13, wherein said operating system comprises Windows.

15. The virtual COM port for remote I/O controller according to claim 13, wherein said operating system comprises Linux.

16. The virtual COM port for remote I/O controller according to claim 13, wherein said analog sensor comprises an analog sensor interface, connected to said network.

17. The virtual COM port for remote I/O controller according to claim 13, wherein said network comprises Ethernet.

18. The virtual COM port for remote I/O controller according to claim 13, wherein said network comprises Wireless LAN.
